(19) United States
(12) Patent Application Publication
(10) Pub. No.: US 2007/0133589 A1
(43) Pub. Date: Jun. 14, 2007

(54) MUTE PROCESSING APPARATUS AND METHOD

(75) Inventors: Wen-Chuan Lian, Shenzhen (CN); Wen-Sheng Tsai, Shenzhen (CN); Hai-Sheng Li, Shenzhen (CN); Kuan-Hong Hsieh, Shenzhen (CN); Duo Liu, Shenzhen (CN); Cheng Wang, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,521

(22) Filed: Aug. 17, 2006

(30) Foreign Application Priority Data
Dec. 3, 2005 (CN) 200510102100.6

(51) Int. Cl. H04B 7/212; H04J 3/00

(52) U.S. Cl. 370/442; 370/498

(57) ABSTRACT

A mute processing method used in a multi-person communication system is provided. The method is capable of automatically sending mute frames when there are no sound inputs from terminals of the multi-person communication system. The method includes the steps of: collecting input signals from a microphone; calculating an energy level of the input signals within a present time span; obtaining a maximum amplitude of the input signals within the present time span; sending a mute frame if the energy level and the maximum amplitude of the input signals within the present time span are respectively less than a predetermined energy level and a predetermined amplitude, otherwise, coding the input signals within the present time span; and outputting the mute frame or coded signals. A related apparatus is also provided.

### TECHNICAL FIELD

The present invention relates to mute processing apparatuses and methods, and particularly to a mute processing apparatus and method for automatically sending mute frames during a multi-person communication over a network.

### GENERAL BACKGROUND

With the development of communication networks and the associated services, a multi-person communication has been introduced and regarded as one typical service in the communication networks, such as the Public Switched Telephone Network (PSTN) and the Voice over Internet Protocol (VOIP) Network. Furthermore, the multi-person communication has been also pervasively applied in a network telephone conversation or a network TV conversation. Such multi-person communication can support multiple persons simultaneously to communicate, and deliver speech data from broadcaster(s) to the listeners.

In order to provide a friendly communication environment, it is critical for the multi-person communication to utilize system resources to reduce delay, namely to deliver the speech data to each person as soon as possibly. With respect to the delay problem, controlling a transferring amount of the speech data is an effective method to solve the delay problem. However, in the most recently multi-person communication, it transfers all speech data regardless of sound data or soundless data over the communication network. In other words, the soundless data is send over the communication network as well as the sound data. As a result, the soundless data increases a loading of the communication network and the transferring amount of the speech data. Consequently, a delay phenomenon may appear due to the unnecessary soundless data, therefore, a service quality of the multi-person communication system may be weaken due to the delay phenomenon.

What is needed, therefore, is a mute processing apparatus and method used in the multi-person communication system, which can automatically send mute frames when there are no sound inputs from terminals of the multi-person communication system without sending unnecessary soundless data, thereby reducing the transferring amount of the speech data due to rather less sizes of the mute frames as compared to the soundless data.

### SUMMARY

A mute processing apparatus is provided. The apparatus is capable of automatically sending mute frames when persons don't talk or keep mute during a multi-person communication over a network. The apparatus mainly includes a sampling unit, an energy calculating unit, an amplitude analyzer, a coding unit, a processing unit, and an output unit. The sampling unit is for collecting input signals from a microphone. The energy calculating unit is for calculating an energy level of the input signals within a present time span. The amplitude analyzer 12 is for obtaining a maximum amplitude of the input signals within the present time span. The coding unit is for coding the input signals within the present time span. The processing unit is for sending a mute frame within the time span if the energy level and the maximum amplitude of the input signals within the present time spans are respectively less than a predetermined energy level and a predetermined amplitude, otherwise, controlling the coding unit to code the input signals within the present time span. The output unit is for outputting the mute frame from the processing unit or coded signals from the coding unit.

A mute processing method is also provided. The method includes the steps of: (a) collecting input signals from a microphone; (b) calculating an energy level of the input signals within a present time span; (c) obtaining a maximum amplitude of the input signals within the present time span; (d) sending a mute frame if the energy level and the maximum amplitude of the input signals within the present time spans are respectively less than a predetermined energy level and a predetermined amplitude, otherwise, coding the input signals within the present time span; and (e) outputting the mute frame or coded signals.

Other advantages and novel features will be drawn from the following detailed description with reference to the attached drawing, in which:

### BRIEF DESCRIPTION OF DRAWINGS

FIG. 1 is a schematic diagram of a hardware infrastructure of a mute processing apparatus for automatically sending mute frames during a multi-person communication over a network in accordance with a preferred embodiment of the present invention; and

FIG. 2 is a flowchart of a preferred mute processing method for automatically sending mute frames during a multi-person communication over a network by utilizing the apparatus of FIG. 1.

### DETAILED DESCRIPTION

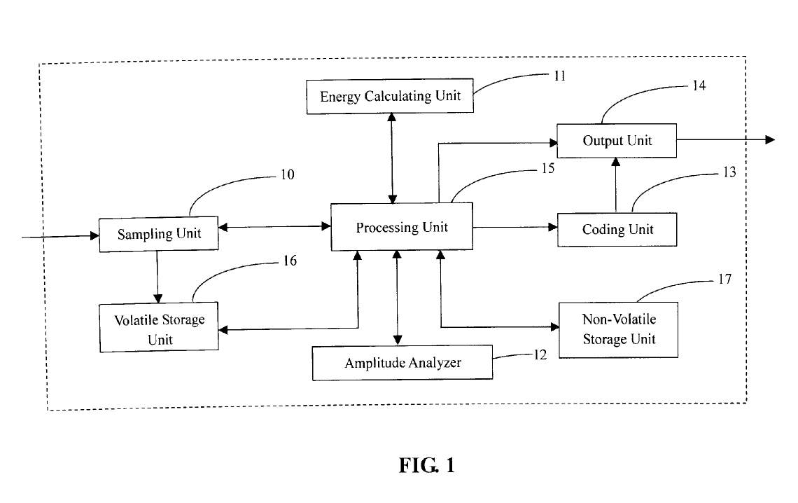

FIG. 1 is a schematic diagram of a hardware infrastructure of a mute processing apparatus (hereinafter, “the apparatus”) in accordance with a preferred embodiment of the present invention. The apparatus is used in a multi-person communication system, and preferably, is incorporated into each terminal of the multi-person communication system. The apparatus is capable of automatically sending mute frames when there are no sound inputs on any terminal ends during a multi-person communication, thereby reducing a loading of a network responsible for transmitting data throughout the terminals. The apparatus includes a sampling unit 10, an energy calculating unit 11, an amplitude analyzer 12, a coding unit 13, an output unit 14, a processing unit 15, a volatile storage unit 16, and a non-volatile storage unit 17.

The sampling unit 10 is for collecting input signals from a microphone (not shown) connected to the apparatus.

The energy calculating unit 11 is for calculating an energy level of the input signals within a present time span. That is, the energy calculating unit 11 regards the input signals within one time span as an input period, and calculates the energy level of each input period.

The amplitude analyzer 12 is for obtaining a maximum amplitude of the input signals within a present time span. That is, the amplitude analyzer 12 similarly regards the input signals within one time span as an input period, and obtains the maximum amplitude of each input period.

If the energy level and the maximum amplitude of the input period are respectively equal to or greater than a predetermined energy level and a predetermined amplitude, that means the terminal of the multi-person communication is inputting sound within the present time span, therefore, a speech coding operation is required on the input signals of the input period to obtain coded signals to be sent out over the network.

If the energy level/maximum amplitude of the input period is equal or equal to the predetermined energy level/amplitude whereas the maximum amplitude/energy level of the input period is less than the predetermined amplitude/energy level, that means the terminal of the multi-person communication may have one or more input pauses within the present time span, therefore, the speech coding operation is required on the input signals of the input period to obtain coded signals to be sent out over the network.

If the energy level and the maximum amplitude of the input period are respectively less than the predetermined energy level and the predetermined amplitude, that means there is no sound input from the terminal of the multi-person communication within the present time span, therefore, a mute frame is sent within the present time span instead of performing a speech coding operation on the input signals of the input period.

The coding unit 13 is for performing the speech coding operation on the input signals within the present time span, that is, for coding the input signals of the input period. The output unit 14 is for outputting coded signals from the coding unit 13 or the mute frame.

The processing unit 15 is for controlling the components of the apparatus, i.e., the sampling unit 10, the energy calculating unit 11, the amplitude analyzer 12, the coding unit 13, the output unit 14, the volatile storage unit 16, and the non-volatile storage unit 17.

The processing unit 15 signals the coding unit 13 to perform the speech coding operation on the input signals of the input period within the present time span, if the energy level and the maximum amplitude of the input period are respectively equal to or greater than the predetermined energy level and the predetermined amplitude.

The processing unit 15 also signals the coding unit 13 to perform the sound coding operation on the input signals of each input period within the present time span, if the energy level/maximum amplitude of the input period is equal or equal to the predetermined energy level/amplitude whereas the maximum amplitude/energy level of the input period is less than the predetermined amplitude/energy level.

Moreover, the processing unit 15 sends the mute frame instead of performing the sound coding operation on the input signals of the input period, if the energy level and the maximum amplitude of the input period are respectively less than the predetermined energy level and the predetermined amplitude. Simultaneously, the processing unit 15 signals the output unit 14 to output the mute frame.

Therefore, in the case when the energy level and the maximum amplitude of the input period are respectively less than the predetermined energy level and the predetermined amplitude, the apparatus simply sends the mute frame within each corresponding time span of the input periods. Otherwise, the apparatus sends coded signals within each corresponding time span. Because a size of the mute frame is relative smaller than a size of the input period coded signals, a transferring amount of the mute frame is consequentially less than a transferring amount of the coded signals of the input period. As a result, a loading of the network is available to be reduced due to less transferring amounts of mute frames, thereby eliminating delay phenomena.

Additionally, the volatile storage unit 16 is configured for storing the input signals of different input periods, the energy level and the maximum amplitude of the input signals of each of the different input periods. The non-volatile storage unit 17 is configured for storing the predetermined energy level and the predetermined amplitude.

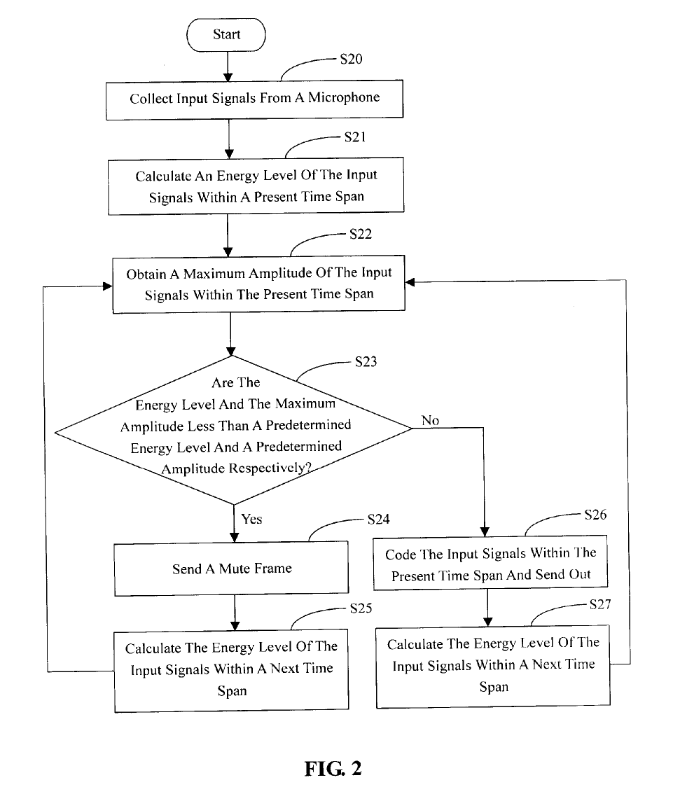

FIG. 2 is a flowchart of a preferred mute processing method for automatically sending mute frames during the multi-person communication over the network by utilizing the apparatus of FIG. 1. In step S20, the sampling unit 10 collects the input signals from the microphone connected thereto. In step S21, the energy calculating unit 11 calculates the energy level of the input signals within a present time span. In step S22, the amplitude analyzer 12 obtains the maximum amplitude of the input signals within the present time span. In step S23, the processing unit 15 detects whether the energy level calculated and the maximum amplitude obtained are respectively less than the predetermined energy level and the predetermined amplitude.

If the energy level calculated and the maximum amplitude obtained are respectively less than the predetermined energy level and the predetermined amplitude, that means there is no sound input from the terminal of the multi-person communication within the present time span, in step S24, the processing unit 15 signals the output unit 14 to output the mute frame over the network, thereby reducing the loading of the network. In step S25, the energy calculating unit 11 calculates the energy level of the input signals within a next time span, and the procedure returns to step S22 described above.

If the energy level calculated and the maximum amplitude obtained are not simultaneously less than the predetermined energy level and the predetermined amplitude respectively, that is, if the energy/maximum amplitude is equal to or greater than the predetermined energy/amplitude whereas the maximum amplitude/energy level is less than the predetermined amplitude/energy level, or the energy level and the maximum amplitude are respectively equal to or greater than the predetermined energy level and the predetermined amplitude, that means the terminal of the multi-person communication may have one or more input pauses within the present time span or the terminal of the multi-person communication is inputting sound within the present time span, therefore, in step S26, the processing unit 15 signals the coding unit 13 to perform the speech coding operation on the most recent input signal of the input period, and simultaneously signals the output unit 14 to send out the coded signals from the coding unit 13 through the network. In step S27, the energy calculating unit 11 calculates the energy level of the input signals within a next time span, and the procedure returns to step S22 described above.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. A mute processing apparatus for automatically sending mute frames during a multi-person communication over a network, the apparatus comprising:
a sampling unit, for collecting input signals from a microphone;
an energy calculating unit, for calculating an energy level of the input signals within a present time span;
an amplitude analyzer, for obtaining a maximum amplitude of the input signals within the present time span;
a coding unit, for coding the input signals within the present time span;
a processing unit, for sending a mute frame within the present time span if the energy level and the maximum amplitude of the input signals are respectively less than a predetermined energy level and a predetermined amplitude, otherwise controlling the coding unit to code the input signals within the present time span; and
an output unit, for outputting the mute frame from the processing unit or coded signals from the coding unit.

2. The apparatus according to claim 1, further comprising a volatile storage unit for storing the input signals of different time spans, the energy level and the maximum amplitude of the input signals of each of the different time spans.

3. The apparatus according to claim 2, further comprising a non-volatile storage unit for storing the predetermined energy level and the predetermined amplitude.

4. A mute processing method for automatically sending mute frames during a multi-person communication over a network, the method comprising the steps of:
collecting input signals from a microphone;
calculating an energy level of the input signals within a present time span;
obtaining a maximum amplitude of the input signals within the present time span;
sending a mute frame if the energy level and the maximum amplitude of the input signals within the present time span are respectively less than a predetermined energy level and a predetermined amplitude, otherwise, coding the input signals within the present time span; and
outputting the mute frame or coded signals.

5. The method according to claim 4, further comprising the step of: providing a volatile storage unit and a non-volatile storage unit, the volatile storage unit being configured for storing the input signals of different time spans, and the energy level and the maximum amplitude of the input signals of each of the different time spans, and the non-volatile storage unit being configured for storing the predetermined energy level and the predetermined amplitude.
